(19) United States
(12) Patent Application Publication
(10) Pub. No.: US 2025/0236516 A1
(43) Pub. Date: Jul. 24, 2025

(54) REACTOR, AND DEVICE AND METHOD FOR CRACKING AMMONIA

(71) Applicant: WS - Wärmeprozesstechnik GmbH, Renningen (DE)

(72) Inventors: Joachim A. Wünning, Leonberg (DE); Joachim G. Wünning, Leonberg (DE)

(73) Assignee: WS - Wärmeprozesstechnik GmbH, Renningen (DE)

(21) Appl. No.: 18/691,969

(22) PCT Filed: Dec. 10, 2021
(86) PCT No.: PCT/EP2021/085270

§ 371 Date: Mar. 14, 2024

(30) Foreign Application Priority Data
Sep. 14, 2021 (EP) 21196507.4

(51) Int. Cl. C01B 3/04; B01J 8/00; B01J 8/06; B01J 19/24

(52) U.S. Cl. CPC C01B 3/047; B01J 8/0005; B01J 8/062; B01J 19/2425; B01J 19/248; B01J 2208/00194; B01J 2208/00504; B01J 2208/0053; B01J 2208/065; C01B 2203/043; C01B 2203/066; C01B 2203/085

(57) ABSTRACT

The invention relates to a reactor for autothermal or endothermic reactions, in particular for cracking ammonia, said reactor comprising: an inlet (12) for supplying a starting gas and an outlet (13) for discharging cracking gas; a reactor chamber (14) filled with a catalyst (2); and a flat-tube heat exchanger (3) located in the reactor (1), the flat-tube heat exchanger (3) being positioned in such a way that a starting gas flowing to the reactor chamber (14) and a cracking gas flowing out of the reactor chamber (14) can flow therethrough, so that energy from the out-flowing cracking gas can be transferred to the supplied starting gas. The invention also relates to: devices (100) for autothermal or endothermic reactions; a module (700); and a method for autothermal or endothermic reactions.

### FIELD OF APPLICATION AND PRIOR ART

The invention relates to a reactor and to an apparatus, a module and a method for carrying out autothermic or endothermic reactions, in particular for cracking ammonia.

At present, approximately 150 million tonnes of ammonia are produced worldwide every year, primarily for the fertilizer industry.

Ammonia consists of nitrogen and hydrogen. Since it is much easier to handle, transport and store ammonia than it is to handle hydrogen, ammonia is also used as a hydrogen storage means and for the transport of hydrogen.

At present, a hydrogen required for synthesis is still predominantly obtained by steam reforming of natural gas, during which large amounts of CO2 are emitted. However, there are currently numerous projects for producing what is referred to as green ammonia from separated atmospheric nitrogen and green hydrogen, i.e. hydrogen from solar or wind power, in large-scale plants by means of catalytic synthesis.

This green ammonia is also advantageous for the future energy industry, since it makes it possible to inexpensively transport green hydrogen in liquid form to the end consumer. For reconversion to hydrogen, use is made of ammonia cracking apparatuses (usually referred to as ammonia crackers), which crack ammonia into 75% H2 and 25% N2. This cracking gas can either be converted directly to power in fuel cells or processed to afford hydrogen, for example for fueling bus fleets, trucks and ships.

By contrast to the production of ammonia, in particular also green ammonia, in large-scale plants, reconversion of the ammonia to hydrogen should take place decentrally, in particular directly with the consumer.

It is known to carry out reconversion or cracking of ammonia as an endothermic reaction, during which the energy required must be supplied from the outside.

Endothermic ammonia cracking is expedient in particular when a residual gas, such as an anode residual gas from a fuel cell or a purge gas from a pressure-swing plant for obtaining pure hydrogen, is available for the heating.

As an alternative, it is known to carry out ammonia cracking autothermic. In this case, it is known to admix an oxidizer with the ammonia, which is supplied in liquid or gaseous form. The supply of oxygen is calculated such that a temperature favorable for ammonia cracking on a catalyst is produced, for example 850° C.

### Problem and Solution

An object of the invention is to provide a compact reactor for autothermic or endothermic reactions at high temperatures, in particular for cracking ammonia, with a high degree of efficiency. Other objects of the invention are to provide an apparatus and a module comprising a reactor for endothermic reactions and a method for carrying out endothermic reactions with a high degree of efficiency.

These objects are achieved by the subject matter having the features of claims 1, 8, 13 and 15. Further advantageous embodiments emerge from the dependent claims.

A first aspect provides a reactor for autothermic or endothermic reactions, in particular for cracking ammonia, comprising an inlet for supplying a starting gas and an outlet for discharging cracking gas, and comprising a reactor chamber filled with a catalyst, wherein a flat-tube heat exchanger comprising flat tubes with flow channels for the flow of the supplied starting gas and the outflowing cracking gas in and between the flat tubes is disposed in the reactor in such a way that a starting gas flowing to the reactor chamber and a cracking gas flowing out of the reactor chamber can flow through the flat-tube heat exchanger, such that energy from the outflowing cracking gas can be transferred to the supplied starting gas.

In connection with the application, the term “a” is used as indefinite article and not as a numerical word. Similarly, in connection with the application, the terms “first” and serve “second” merely for differentiation and do not specify a sequence. The term “first” also does not necessarily require the presence of structurally identical or similar second elements.

The starting gas referred to in connection with the application is a gas or gas mixture supplied to the reactor. The cracking gas referred to is a gas mixture which is obtained through the reaction and in particular comprises hydrogen obtained through the endothermic reaction.

The reactor is suitable for autothermic or endothermic reactions at high temperatures. The high temperatures referred to in connection with the application are temperatures of above 600° C.

The flat-tube heat exchanger makes it possible to recover heat of the cracking gas that remains after the autothermic or endothermic reaction carried out at high temperatures. In this respect, in one embodiment for an autothermic reaction the supply of heat to the reactor chamber from the outside can be dispensed with. In the case of an endothermic reaction, the requirement for heat energy for the endothermic reaction carried out in the reactor chamber can thus be reduced. Flat-tube heat exchangers are characterized in particular by a large heat exchanger surface area together with a relatively small structural space. Moreover, flat-tube heat exchangers are resistant to mechanical stresses due to rapid changes in load or temperature. The flat-tube heat exchanger is integrated in the reactor, and therefore a compact solution is provided.

In particular, the starting gas is ammonia. Depending on the configuration of the flat-tube heat exchanger and the reactor chamber, it is possible here to obtain a reactor for endothermic cracking of ammonia with a degree of efficiency (H2 calorific value/NH3 calorific value) of at least 80%, in particular at least 85%. An oxidizer, in particular oxygen or air, is admixed with the starting gas for an autothermic reaction. In one configuration, an oxygen used as oxidizer is obtained by water electrolysis with green surplus power, wherein a hydrogen accrued in the process can be admixed with the cracking gas.

In the case of autothermic ammonia cracking, it is possible to achieve a degree of efficiency of more than 85%, in n particular up to 90%. The further improvement in the degree of efficiency over endothermic ammonia cracking is possible owing to the lack of waste gas losses of a burner for supplying energy for the endothermic reaction. Moreover, the reactor can be made more compact, and therefore losses through the walls or the like can be reduced. The use of the reactor for autothermic ammonia cracking is therefore also suitable for small outputs up to 20 kW, for example for the CO2-free supply of power and heat to dwellings using green ammonia.

However, the reactor can also be used for other starting gases, it also being possible for the starting gas to be a gas mixture. For example, it is conceivable to use the reactor for steam reforming, in particular of natural gas. In this respect, in one embodiment it may also be provided that multiple starting gases are supplied to the reformer, and depending on the configuration all the starting gases or only some of the starting gases are heated in the flat-tube heat exchanger.

Those skilled in the art will be able to design the flat-tube heat exchanger suitably depending on the usage situation, so that the flat-tube heat exchanger is suitable for high temperatures. In advantageous embodiments, the flat-tube heat exchanger is a counterflow heat exchanger, wherein the flat-tube heat exchanger is disposed in such a way that the starting gas flowing to the reactor chamber and the cracking gas flowing out of the reactor chamber can flow through said flat-tube heat exchanger in opposite directions. However, other structural forms are also conceivable.

The autothermic or endothermic reaction, in particular the cracking of ammonia, takes place in the reactor, and therefore the cracking gas flowing out of the reactor can be utilized in a combustion process, or used for other purposes, as required. For example, a hydrogen of the cracking gas can be converted into power in a fuel cell and/or can be processed to afford pure hydrogen, for example in a pressure-swing plant. In particular, the endothermic reaction takes place separate from a combustion chamber for heating the reactor.

In one application, a liquid ammonia is evaporated prior to being supplied to the reactor. In advantageous embodiments, cooling power generated during an evaporating operation can be used in another way.

A high-temperature flat-tube heat exchanger for gaseous media is known, for example, from EP 2 584 301 A1, to the entirety of which reference is hereby made. However, the invention is not restricted to the use of a heat exchanger known from EP 2 584 301 A1.

In one embodiment, a gap width of the flow channels is less than 3 mm. A close arrangement of the flat tubes ensures good heat transfer together with a small structural space.

In one embodiment, the flat-tube heat exchanger is configured such that a heat exchanger surface area is approximately 2 times to approximately 4 times a heated surface area of the reactor. For example, in the case of a reactor for cracking ammonia, it is provided that the heat exchanger surface area, in m2, is approximately 0.06 to 0.1 times, in particular 0.08 times, the ammonia throughput in kg/h.

In one embodiment, the reactor comprises an outer tube with a first end, at which the inlet and the outlet are disposed, and with a closed second end, wherein the flat-tube heat exchanger is a cylindrical flat-tube heat exchanger, which is disposed in the outer tube between the first end and the reactor chamber.

The cylindrical flat-tube heat exchanger referred to in connection with the application is a flat-tube heat exchanger in which the flat tubes are disposed on concentric circles. In one embodiment, the same number of flat tubes is provided on each circle. In one embodiment, corrugated spacers, which are used to further enlarge a heat exchanger surface area, are disposed between the tubes.

The reactor chamber and the flat-tube heat exchanger are suitably connected to one another such that the starting gas supplied via the inlet is supplied to the reactor chamber through first flow channels of the heat exchanger and the cracking gas flowing out of the reactor chamber is conducted to the outlet through second flow channels of the heat exchanger.

In one embodiment, it is provided that the reactor has an inner tube disposed in the reactor chamber, preferably two inner tubes disposed in the reactor chamber, wherein the one or more inner tubes disposed in the reactor chamber is/are connected to the inlet via first flow channels of the heat exchanger. When used for cracking ammonia, the reactor is preferably set up in such a way that the flat-tube heat exchanger is disposed above the reactor chamber. By means of the inner tubes, the ammonia preheated in the flat-tube heat exchanger is conducted under the catalyst disposed in the reactor chamber and can flow upward, around the inner tubes, into the outer tube via the catalyst for the purpose of cracking the ammonia, the outer tube being heatable from the outside.

In one use of the reactor, the cracking gas flowing out of the reactor is then processed in a pressure-swing plant for separating the gas mixture. For this purpose, in one embodiment, the reactor, in particular the outer tube of the reactor, is designed for an excess pressure, in particular for an excess pressure up to at most 20 bar.

In one embodiment of the reactor, a channel for supplying the catalyst is provided, wherein the flat-tube heat exchanger preferably surrounds the channel. This enables a compact structure, wherein a supply of the catalyst from a first end of the reactor is possible. This allows supply of the catalyst even in an installed state.

In one embodiment, it is provided that at least the reactor chamber can be heated from the outside for an endothermic reaction and/or for startup. In one embodiment, an outer tube of the reactor is made of a suitable material with good heat transfer. In one embodiment, the outer tube is surrounded in the region of the reactor chamber by a heating device, in particular a heating device which can be operated by means of electrical energy, wherein the reactor chamber can be heated externally for initiating an autothermic reaction. In other embodiments, the reactor chamber is disposed in a combustion chamber for the supply of heat, in particular for an endothermic reaction.

A second aspect provides an apparatus for autothermic reactions, in particular for cracking ammonia, comprising a reactor, wherein thermal insulation surrounding the reactor is provided. The apparatus is distinguished by a high degree of efficiency of up to 90%. The thermal insulation surrounds the reactor and a heating device provided, if appropriate, for startup, it being possible to keep losses through the walls low by virtue of a compact structure.

In one embodiment, an evaporator, through which the starting gas flowing to the flat-tube heat exchanger and the cracking gas flowing out of the flat-tube heat exchanger can flow, is provided. A downstream evaporator makes it possible to cool the cracking gas down to room temperature. In the case of autothermic ammonia cracking, the cracking gas comprises hydrogen, nitrogen and oxygen, wherein a water of reaction can be condensed and deposited.

A third aspect provides an apparatus for endothermic reactions, particular for cracking ammonia, comprising a thermally insulated combustion chamber and a reactor, wherein the reactor chamber of the reactor is disposed in the combustion chamber, separate therefrom as far as material is concerned.

As mentioned, in connection the with application, the term “a” is used as indefinite article and not as a numerical word. In particular, in one embodiment, the apparatus comprises more than one, for example two, three, four or more than ten, in particular up to twenty or more reactors, wherein, depending on a number of reactors, a capacity of the apparatus can be adapted as required, for example to 100 kg/h hydrogen.

Those skilled in the art will be able to configure the combustion chamber and the burner suitably depending on the usage situation, so that a temperature required for the endothermic reaction in the reactor chamber can be generated in the combustion chamber.

In one embodiment, a burner, which can be operated by means of the cracking gas, an anode residual gas from a fuel cell and/or a purge gas from a pressure-swing plant, is provided. The burner is a recuperative or regenerative burner, so that it is possible to recover waste-gas heat to further improve the energy efficiency.

In one embodiment, the reactor chamber is disposed in the combustion chamber in such a way that a gas stream through the reactor chamber can be heated on the codirectional flow principle by a heating gas flowing on an outer side of the reactor chamber.

As an alternative or in addition to a burner, in one embodiment the combustion chamber can be heated by means of electrical energy. Heating by means of electrical energy is conceivable in particular during pauses in operation of the reactor, when no gas is generated for the operation of a burner and a temperature of the reactor is to be maintained, and/or when the apparatus is started up following a pause in operation.

In one embodiment, the reactor is inserted in a support serving as a cover for the combustion chamber. In the event of a structure with multiple reactors, in one embodiment multiple reactors and a burner are inserted in a shared support. A module provided in this way can be used on its own or in combination with further modules depending on the usage situation.

Correspondingly, a fourth aspect provides a module comprising multiple reactors, in particular four reactors, and a burner, wherein the reactors and the burner are mounted on a support.

In one embodiment, the support is at least partially manufactured from a thermally insulating material and surrounds the reactors in the region of the heat exchanger. The module is preferably placed onto a combustion chamber from above, with the inlet, outlet and—if present—a channel for supplying the catalyst being accessible from above.

A fifth aspect provides a method for carrying out autothermic or endothermic reactions in a reactor comprising an inlet for supplying a starting gas and an outlet for discharging cracking gas, comprising a reactor chamber filled with a catalyst, and comprising a flat-tube heat exchanger disposed in the reactor upstream of the reactor chamber, wherein a supplied starting gas and an outflowing cracking gas flow through the flat-tube heat exchanger, such that energy from the outflowing cracking gas is transferred to the supplied starting gas.

In particular, what is provided is a method for cracking ammonia in a reactor comprising an inlet for supplying ammonia and an outlet for discharging cracking gas, comprising a reactor chamber filled with a catalyst, and comprising a flat-tube heat exchanger disposed in the reactor upstream of the reactor chamber, wherein a supplied ammonia and an outflowing cracking gas flow through the flat-tube heat exchanger, such that energy from the outflowing cracking gas is transferred to the supplied ammonia.

In this case, in one embodiment for autothermic cracking an oxidizer, for example air or oxygen, is supplied to the ammonia. The supply of oxygen is calculated such that a temperature favorable for NH3 cracking on the catalyst is produced, for example 850° C. For example, in one embodiment, air is admixed in a ratio of approximately 1 m3/kg NH3 or oxygen is admixed with a ratio of approximately 0.2 m3/kg NH3.

### BRIEF DESCRIPTION OF THE DRAWINGS

Further advantages and aspects of the invention result from the claims and from the description of exemplary embodiments of the invention which are explained below with reference to the figures, in which:

FIG. 1: shows a longitudinal section through a reactor comprising a reactor chamber and a flat-tube heat exchanger,

FIG. 2: shows a cross section along the sectional line II-II according to FIG. 1 through the reactor according to FIG. 1,

FIG. 3: shows a cross section along the sectional line III-III according to FIG. 1 through the reactor according to FIG. 1,

FIG. 4: shows a longitudinal section through an apparatus for an endothermic reaction, comprising a reactor according to FIG. 1,

FIG. 5: shows a temperature profile of the gas streams in an apparatus according to FIG. 4,

FIG. 6: shows a perspective illustration of a module comprising four reactors according to FIG. 1,

FIG. 7: shows a perspective illustration of an apparatus comprising four modules according to FIG. 6, and

FIG. 8: shows a longitudinal section through an apparatus for an autothermic reaction, comprising a reactor according to FIG. 1.

### DETAILED DESCRIPTION OF THE EXEMPLARY EMBODIMENTS

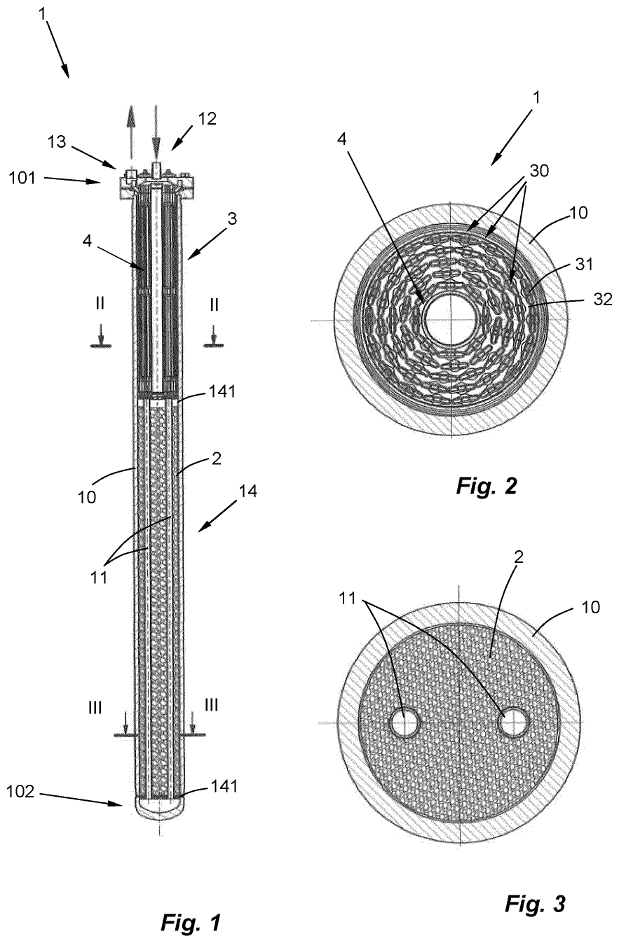

FIGS. 1 to 3 show a longitudinal section, a cross section along a sectional line II-II according to FIG. 1, and a cross section along a sectional line III-III according to FIG. 1 through a reactor 1 for autothermic or endothermic reactions, in particular for cracking ammonia.

The reactor 1 illustrated comprises an outer tube 10 and two inner tubes 11. The outer tube 10 has a first end 101, which is disposed at the top in the use position illustrated and at which an inlet 12 for supplying a starting gas and an outlet 13 for discharging cracking gas are provided. A second end 102, opposite said first end, of the outer tube 10 is closed.

A reactor chamber 14 filled with a catalyst 2 is provided in the outer tube 10, and in the exemplary embodiment illustrated the reactor chamber 14 is delimited at both ends by closure plates 141. The inner tubes 11 extend through the reactor chamber 14, the catalyst 2 being disposed around the inner tubes 11. In the exemplary embodiment illustrated, two inner tubes 11 are provided. In other embodiments, only one inner tube is provided or more than two inner tubes are provided.

A flat-tube heat exchanger 3 is disposed in the outer tube 10 between the first end 101 and the reactor chamber 14. In the exemplary embodiment illustrated, the flat-tube heat exchanger 3 is disposed above the reactor chamber 14 in the outer tube 10. The flat-tube heat exchanger 3 illustrated is in the form of a cylindrical flat-tube heat exchanger with flat tubes 30, which are disposed along concentric circles.

A channel 4 for supplying the catalyst 2 is provided in the middle in the region of the flat-tube heat exchanger 3, the flat tubes 30 being disposed around the channel 4 in the exemplary embodiment illustrated.

Flow channels, which are denoted first flow channels 31 and second flow channels 32, are formed in the flat tubes 30 and around the flat tubes 30.

In the exemplary embodiment illustrated, the flat-tube heat exchanger 3 is connected to the inlet 12 and the reactor chamber 14 such that a starting gas supplied to the reactor chamber 14 flows through the first flow channels 31 upstream of the reactor chamber 14 and a cracking gas flowing out of the reactor chamber 14 flows through the second flow channels 32, such that energy from the outflowing cracking gas can be transferred to the supplied starting gas.

In another embodiment, the first flow channels for the suppled starting gas are provided around the flat tubes 30 and the second flow channels for the outflowing cracking gas are provided in the flat tubes 30.

The first flow channels 31 for the supplied starting gas are connected to the inner tubes 11, so that the starting gas preheated in the flat-tube heat exchanger 3 is conducted under the catalyst 2 disposed in the reactor chamber 14 through the inner tubes 11.

The reactor 1 serves to carry out autothermic or endothermic reactions, such as cracking of ammonia to afford hydrogen and nitrogen. During use, for the endothermic reaction the reactor chamber 14 is heated from the outside, in particular to temperatures above 600° C. For autothermic operation, in one embodiment, the reactor chamber is heated solely during startup. An oxidizer is admixed with the starting gas. Later on, exothermic and endothermic reactions proceed in the reactor at the same time, so that a supply of heat from the outside can be omitted.

The cracking gas that was generated by the cracking and flows out of the reactor chamber comprises heat. Using the heat exchanger 3, it is possible to recover the heat of the cracking gas and thus reduce a requirement for heat energy for the autothermic or endothermic reaction, in particular for cracking of ammonia, carried out in the reactor chamber 14.

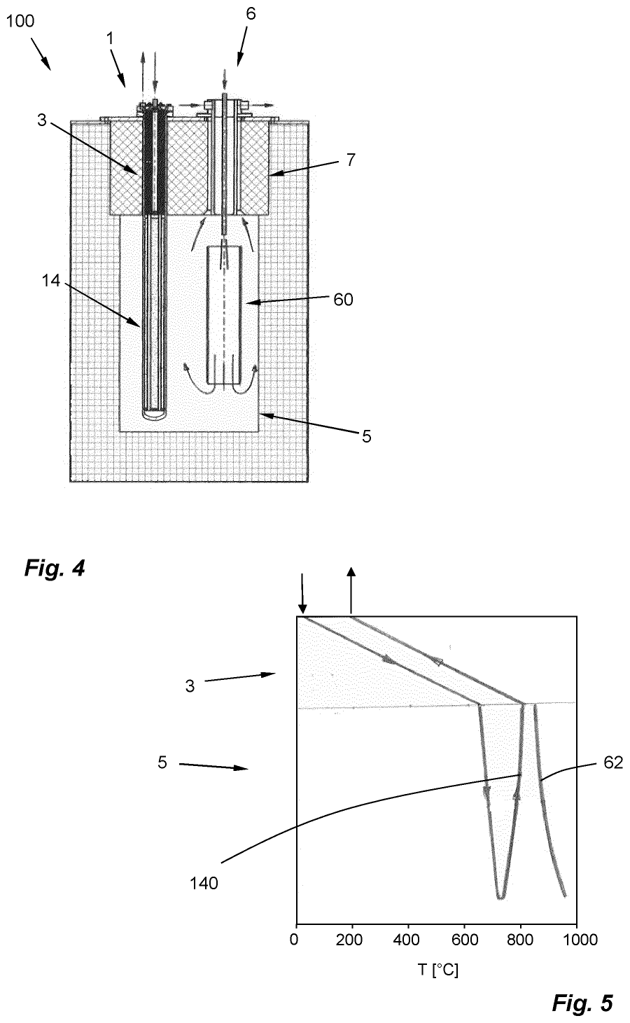

FIG. 4 schematically shows a longitudinal section through an apparatus 100 for endothermic reactions, in particular for cracking ammonia, comprising a thermally insulated combustion chamber 5, a burner 6 and a reactor 1 according to FIG. 1. In the exemplary embodiment illustrated, the burner 6 and the reactor 1 are disposed in a shared support 7. In the exemplary embodiment illustrated, the support 7 serves as a cover, by means of which the combustion chamber 5 can be closed from above. All the connections of the reactor 1 and of the burner 6 can be accessed from above in this case.

The support 7 makes it possible to position the reactor 1 on the combustion chamber 5 in such a way that the reactor chamber 14 of the reactor 1 is disposed in the combustion chamber 5, the reactor chamber 14 being separate from the combustion chamber 5 as far as material is concerned and heated from the outside via heat generated in the combustion chamber 5.

In the exemplary embodiment illustrated, the flat-tube heat exchanger 3 of the reactor 1 is completely surrounded by the support 7. In this respect, in one embodiment the support also serves as thermal insulation for the flat-tube heat exchanger 3.

Those skilled in the art can configure the burner 6 suitably, with the burner 6 preferably, as indicated by arrows, being in the form of a recuperative or regenerative burner, and utilizing waste heat from the combustion. In the exemplary embodiment illustrated, a flame tube 60 is provided, with combustion taking place in the flame tube 60 and heating gases being returned along the reactor chamber 14.

In the exemplary embodiment illustrated in FIG. 4, only one reactor 1 is provided. In other embodiments, the apparatus 100 comprises multiple reactors 1.

FIG. 5 schematically shows a temperature profile, in degrees Celsius, of the gas streams in the flat-tube heat exchanger 3 and the combustion chamber 5. As schematically indicated in FIG. 5, flow passes through the flat-tube heat exchanger 3 in a counterflow arrangement, the supplied starting gas being heated by the outflowing cracking gas. In the temperature profile illustrated, the starting gas is heated to a high temperature of above 600° C. The gas stream flowing through the reactor chamber 14 (cf. FIG. 4) is heated by means of the heating gas 62 rising along the outside of the reactor chamber, and because the starting gas was preheated in the flat-tube heat exchanger 3, heating with a smaller temperature difference than in the case of conventional apparatuses is necessary. This also allows heat transfer on the codirectional flow principle by the upwardly flowing heating gas 62, as illustrated schematically in FIG. 5.

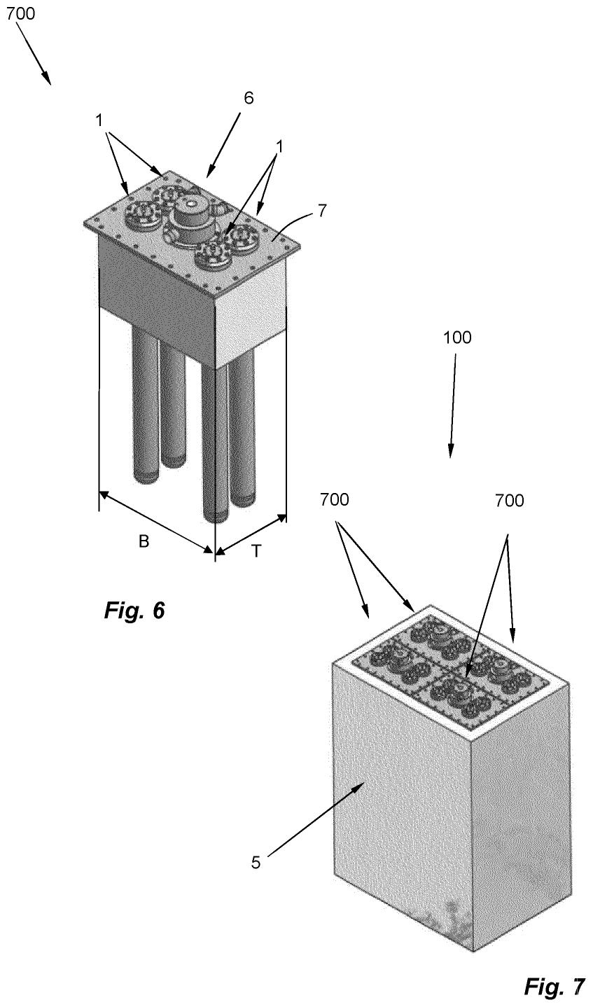

FIG. 6 shows a perspective illustration of a module comprising a support 7, a burner 6 and multiple reactors 1, four in the exemplary embodiment illustrated. The reactors 1 and the burner 6 are mounted on the support 7 and can be assembled on a combustion chamber 5 (cf. FIG. 4) by means of the support 7.

In embodiments, the dimensions of the module 700 are selected such that the module 700 can be provided in the form of a preassembled group of components and transported to a place of use by road.

In one embodiment, the reactors 1 have a length of 2 m, wherein four reactors 1 can be preassembled in a support 7 with an outline having the following dimensions: width B×depth T=0.5 m×0.8 m.

The module 700 can be used on its own or in combination with further modules 700 depending on the usage situation.

FIG. 7 shows a perspective illustration of an apparatus for endothermic reactions, in particular for cracking ammonia, having a thermally insulated combustion chamber 5 comprising four modules 700 according to FIG. 6. As illustrated in FIG. 7, the modules 700 are mounted on a shared combustion chamber 5, the combustion chamber 5 being closed from above by means of the modules 700. The arrangement illustrated is, however, only exemplary and numerous modifications with more or fewer than four modules 700 are conceivable.

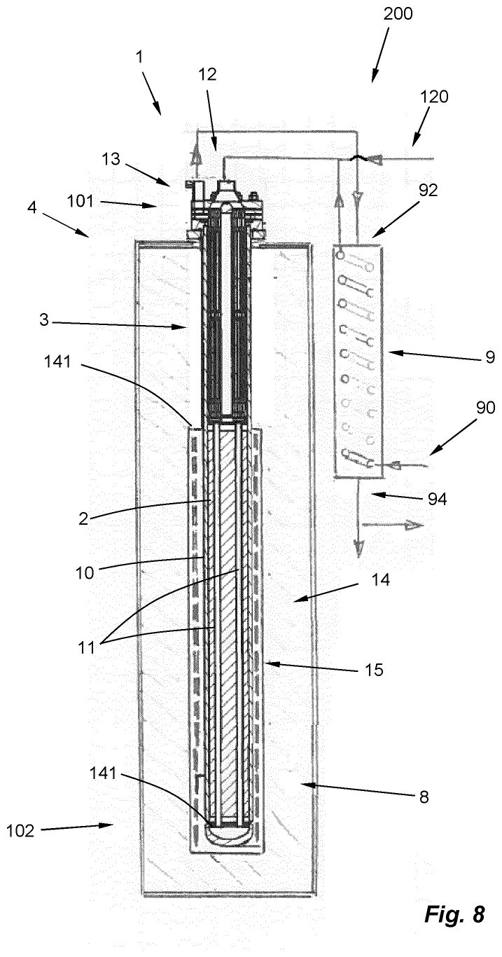

FIG. 8 schematically shows a longitudinal section through an apparatus s 200 for carrying out autothermic reactions, in particular for cracking ammonia, comprising a reactor 1 similar to FIG. 1. Matching reference signs are used in this figure for components that are the same. By contrast to the reactor 1 according to FIG. 1, the reactor 1 according to FIG. 8 additionally has a heating device 15, which surrounds the reactor chamber 14. The heating device 15 is in particular an electric heating device. The heating device 15 makes it possible to supply heat from the outside to the reactor chamber 14 for startup. As operation continues, endothermic and exothermic reactions proceed in the reactor chamber 14, and therefore a supply of heat from the outside can be dispensed with.

To this end, an oxidizer, in particular oxygen or air, is supplied to the starting gas via a supply connection 120 connected to the inlet 12.

The apparatus 200 illustrated has thermal insulation surrounding the reactor 1.

The apparatus 200 also has an evaporator 9, which is upstream in relation to a supplied starting gas and through which the starting gas flowing to the flat-tube heat exchanger 3 and the cracking gas flowing out of the flat-tube heat exchanger 3 flow.

The starting gas, in particular ammonia, is supplied to the evaporator 9 via a supply connection 90. The cracking gas flowing out of the reactor 1 is supplied to the evaporator 9 via a supply connection 92 and cooled in the evaporator 9. Depending on the configuration, cooling down to room temperature is possible here, with condensation of a water vapor present in the cracking gas. The condensate can be deposited at an outlet connection 94 of the evaporator.

By contrast to the apparatuses 100 and modules 700 illustrated in FIGS. 4 to 7, a burner 6 can be omitted in the case of the apparatus 200 according to FIG. 8. The apparatus 200 can therefore be made more compact, with fewer losses through the walls. The apparatus 200 according to FIG. 8 is therefore suitable, among other things, for low outputs up to 20 kW.

1. An apparatus comprising reactor for autothermic or endothermic reactions, in particular for cracking ammonia, and a flat-tube heat exchanger,
the reactor comprising;
an inlet for supplying a starting gas,
an outlet for discharging cracking gas, and
a reactor chamber filled with a catalyst, and
the flat-tube heat exchanger comprising flat tubes with flow channels for the flow of the supplied starting gas and the outflowing cracking gas in and between the flat tubes,
wherein flat-tube heat exchanger is disposed in the reactor in such a way that a starting gas flowing to the reactor chamber and a cracking gas flowing out of the reactor chamber can flow through said flat-tube heat exchanger, such that energy from the outflowing cracking gas can be transferred to the supplied starting gas.

2. The apparatus as claimed in claim 1, wherein a gap width of the flow channels is less than 3 mm.

3. The apparatus as claimed in claim 1, wherein a heat exchanger surface area is approximately 2 times to approximately 4 times a heated surface area of the reactor.

4. The reactor apparatus as claimed in claim 1, wherein the reactor has an outer tube with a first end, at which the inlet and the outlet are disposed, and with a closed second end, wherein the flat-tube heat exchanger is a cylindrical flat-tube heat exchanger, which is disposed in the outer tube between the first end and the reactor chamber.

5. The apparatus as claimed in claim 4, wherein the reactor has an inner tube disposed in the reactor chamber, wherein the inner tube disposed in the reactor chamber is connected to the inlet via first flow channels of the heat exchanger.

6. The apparatus as claimed in claim 4, wherein the outer tube is designed for an excess pressure, in particular for an excess pressure up to at most 20 bar.

7. The apparatus as claimed in claim 1, wherein a channel for supplying the catalyst is provided, wherein the flat-tube heat exchanger preferably surrounds the channel.

8. The apparatus as claimed in claim 1, wherein at least the reactor chamber can be heated from the outside for an endothermic reaction and/or for startup.

9. The apparatus as claimed in claim 1 configured for autothermic reactions, and comprising thermal insulation surrounding the reactor.

10. The apparatus as claimed in claim 9, wherein an evaporator, through which the starting gas flowing to the flat-tube heat exchanger and the cracking gas flowing out of the flat-tube heat exchanger can flow, is provided.

11. The apparatus as claimed in claim 1 configured for endothermic reactions, comprising a thermally insulated combustion chamber, wherein the reactor chamber of the reactor is disposed in the combustion chamber, separate therefrom as far as material is concerned.

12. The apparatus as claimed in claim 11, wherein a burner, which can be operated by means of the cracking gas, an anode residual gas from a fuel cell and/or a purge gas from a pressure-swing plant, is provided, wherein the burner in particular is in the form of a recuperative or regenerative burner.

13. The apparatus as claimed in claim 11, wherein the reactor chamber is disposed in the combustion chamber in such a way that a gas stream through the reactor chamber can be heated on the codirectional flow principle by a heating gas flowing on an outer side of the reactor chamber.

14. The apparatus as claimed in claim 11, wherein the combustion chamber can be heated by means of electrical energy.

15. The apparatus as claimed in claim 11, wherein the reactor is inserted in a support serving as a cover for the combustion chamber.

16. A module comprising multiple apparatuses, in particular four apparatuses, as claimed in claim 1 and a burner, wherein the apparatuses and the burner are mounted on a support.

17. The module as claimed in claim 16, wherein the support is at least partially manufactured from a thermally insulating material and surrounds the reactors in the region of the flat-tube heat exchanger.

18. A method for carrying out autothermic or endothermic reactions, in particular for cracking ammonia, in a reactor, the reactor comprising a reactor chamber filled with a catalyst, an inlet for supplying a starting gas, an outlet for discharging cracking gas, wherein a flat-tube heat exchanger disposed in the reactor upstream of the reactor chamber, wherein a supplied starting gas and an outflowing cracking gas flow through the flat-tube heat exchanger, such that energy from the outflowing cracking gas is transferred to the supplied starting gas.

19. The apparatus as claimed in claim 4, wherein the reactor has two inner tubes disposed in the reactor chamber, wherein the inner tubes disposed in the reactor chamber are connected to the inlet via first flow channels of the heat exchanger.
